(19) United States
(12) Patent Application Publication
(10) Pub. No.: US 2012/0315542 A1
(43) Pub. Date: Dec. 13, 2012

(54) ELECTRODE COATED WITH METAL DOPED CARBON FILM

(75) Inventors: Joong Kee LEE, Seoul (KR); Byung Won CHO, Seoul (KR); Heung Yong HA, Seoul (KR); In Hwan OH, Seoul (KR); Joo Man WOO, Seoul (KR); Ji Hun PARK, Seoul (KR)

(73) Assignee: KOREA INSTITUTE OF SCIENCE AND TECHNOLOGY, Seoul (KR)

(21) Appl. No.: 13/238,046

(22) Filed: Sep. 21, 2011

(30) Foreign Application Priority Data
Jun. 9, 2011 (KR) 10-2011-0055820

(51) Int. Cl. H01M 2/16; H01M 4/62; H01M 4/13; H05H 1/24

(52) U.S. Cl. 429/217; 427/576; 429/223; 429/224; 429/231.3; 429/246

(57) ABSTRACT

Disclosed is an electrode coated with a metal-doped carbon film.

A metal-doped carbon film covers the interface of an electrode active material where it contacts an electrolyte. Such an artificial interface improves ion and electrical conductivity of the electrode interface and prevents pass of water or electrolyte during electrochemical reactions, thereby preventing undesired reactions.

### CROSS-REFERENCE TO RELATED APPLICATIONS

This application claims priority under 35 U.S.C. §119 to Korean Patent Application No. 10-2011-0055820, filed on Jun. 9, 2011, in the Korean Intellectual Property Office, the disclosure of which is incorporated herein by reference in its entirety.

### TECHNICAL FIELD

The present invention relates to an electrode coated with a metal-doped carbon film.

### BACKGROUND

The importance of secondary batteries is expected to grow in proportion to the expansion of the mobile market. In particular, power consumption increases with the increased usage time of PDAs, smart phones and medium-to-large-sized mobile devices as well as the provision of various, colorful services. Accordingly, there is a need of a battery capable of supplying a lot of energy without increasing the size of the device and, thus, there is a demand on a high-capacity electrode material.

Meanwhile, with the growing demand on batteries with high-capacity and large-scale, the stability of batteries has become more important than ever. In order to improve the stability, it is important to prevent interfacial reactions between the electrode material and the electrolyte. Therefore, control of the functionality at the electrode interface becomes necessary. The existing methods have the problems of dissolution, unwanted reaction with the electrolyte, and increased resistance of surface film caused by electrochemical reactions of the lithium-based electrode active material, which cannot be solved only with the improvement of electrolyte characteristics.

To solve these problems, a method of adding a metallic component to the lithium metal oxide electrode active material, a method of mixing an active material with a different lithium ion migration potential with the cathode active material, a method of forming a metal oxide coating film on the entire surface of the cathode active material, and the like have been proposed.

Specifically, as the method of adding a metallic component to the lithium metal oxide electrode active material, a method of preparing a nickel-manganese-cobalt cathode active material Li(Ni_{1-a-b}MnₐCo_{b})_{y}O₂ by adding nickel and manganese to lithium cobalt oxide (Korean Patent Application Publication Nos. 2010-0109605 and 2010-0102382), a method of preparing a material by surface-modifying a lithium complex oxide LiNi₁₋ₓMₓO (wherein M is one or two selected from Co, Al, Mn, Mg, Fe, Cu, Ti, Sn and Cr, and 0.96≦x≦1.05) with carbon or an organic compound (Korean Patent Application Publication No. 2010-0102382), and so forth are reported.

For mixing an active material with a different lithium ion migration potential with the cathode active material, there is a method of preparing a lithium ion battery capable of operating stably at 4.3 V, which is higher than the voltage limit of the existing lithium ion secondary battery by mixing a cobalt/nickel/manganese tricomponent solid-solution cathode active material with a spinel-based manganese active material (LiMn₂O₄) for use as a cathode active material and changing the structure of the electrode plate and the lead tab is reported (Korean Patent Application Publication Nos. 2010-0099359 and 2009-0129817).

As the method of forming a metal oxide coating film on the entire surface of the cathode active material, a cathode active material for a lithium secondary battery comprising a core of lithium metal oxide secondary particles formed from coagulated metal oxide primary particles and a shell formed by coating barium titanate and metal oxide on the secondary particle core (Korean Patent Application Publication No. 2010-0052116), and a metal oxide-coated cathode active material with the entire surface of the cathode active material coated with metal oxide, wherein holes are formed over the entire surface of the metal oxide coating layer from the surface of the cathode active material toward the metal oxide coating layer to allow transport of lithium ions (Korean Patent Application Publication No. 2010-0051705) are reported. Also, a cathode active material comprising a core comprising a compound capable of reversible intercalation/deintercalation of lithium and a surface-treated layer formed thereon comprising a fluoride compound selected from a group consisting of metal fluoride, ammonium metal fluoride and a mixture thereof and a carbon material (Korean Patent Application Publication No. 2010-0007236) is reported.

However, among the existing methods, the metal ion addition method has the problem of uniformity of the various materials added and as well as inhibition of dissolution of only specific electrode active material components. The metal oxide coating method is disadvantageous in that the process is complicated because a uniform coating layer has to be formed and the addition of binder and additives results in decreased effect.

Also, a new technique of forming an artificial interface by coating the cathode active material with a carbon film is reported (Journal of Electroceramics 23 248-253 (2009)). But, in this case, high current characteristics are unsatisfactory because of high surface resistance of the coated carbon film and consequent increased interfacial resistance of the electrode.

### SUMMARY

The present invention is directed to providing an electrode having superior ion conductivity and electrical conductivity.

In one general aspect, the present invention provides a metal-doped carbon film, an electrode active material containing a metal oxide coated with the carbon film, and a method for preparing the same.

Other features and aspects will be apparent from the following detailed description, the drawings, and the claims.

### BRIEF DESCRIPTION OF THE DRAWINGS

The above and other objects, features and advantages of the present invention will become apparent from the following description of certain exemplary embodiments given in conjunction with the accompanying drawings, in which:

FIG. 1 schematically illustrates an electrode of the present invention;

FIG. 2 shows a transmission electron microscopic (TEM) image of a tin-doped carbon film prepared in Example 1;

FIG. 3 shows a result of Test Example 1;

FIG. 4 shows a result of comparing the electrode cycle performance of Comparative Example 1 (1) and Example 1 (2); and

FIG. 5 compares a solid-state nuclear magnetic resonance analysis result of a metal-undoped fullerene sample (A) and a tin-doped fullerene sample.

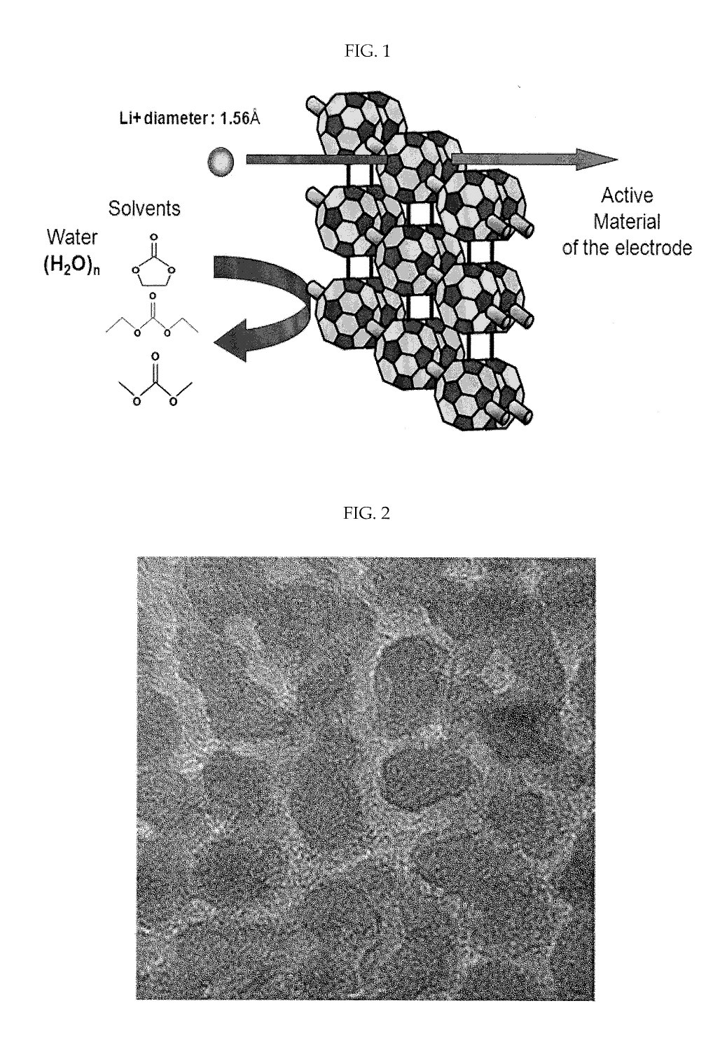

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of the example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments will be described in detail with reference to the accompanying drawings.

The present invention provides an electrode coated with a metal-doped carbon film.

The electrode may comprise an electrode active material, a conductor and a binder.

The electrode active material may be LiCoO2, LiMn2O4, LiNiO2, LiNiCoO2, V₆O₁₃ or V₂O₅ for a lithium secondary battery and may be MnO₂ for a lithium primary battery. The conductor may be acetylene black, carbon black, graphite or a mixture thereof. For good electrode performance, the amount of the conductor needs to be increased. To increase the addition amount of the conductor, the amount of the binder should be also increased. Accordingly, an optimization of the addition amount of the conductor and the binder is necessary, which results in difference in electrode performance. For example, a non-uniform mixing of the active material, the conductor and the binder may result in non-uniform electrode performance, causing the battery reliability problem. The binder serves to prevent deintercalation of the active material and enhance binding of the active material. It may be vinylidene fluoride-hexafluoropropylene copolymer, polyvinylidene fluoride, polyacrylonitrile, poly(methyl methacrylate), polyamide or a mixture thereof. When the binder is used in an unnecessarily large amount, battery performance is degraded because of decrease of the electrode active material and increase of internal resistance. Thus, there is a limitation in increasing the battery performance only by increasing the amount of the conductor.

As described above, although the methods of coating a metal oxide, mixing with an active material with a different lithium ion migration potential, and adding highly stable metal ions to the active material have been proposed in order to solve the problems of the existing lithium oxide-based secondary battery such as dissolution of the active material, volume change, undesired reaction with the electrolyte, reduced performance per unit volume, slurry instability, and accelerated electrolyte decomposition (gas generation), they are not fundamental solutions. The technique of forming an artificial surface film at the electrode interface developed by the inventors of the present invention (solid electrolyte interface; SEI) is very important in the development of next-generation lithium secondary batteries since it allows efficient migration of lithium in the electrode active material, improved electrical field formation in the electrode active material, reduced side reactions of the electrode active material, and prevention of abrupt contact of lithium dendrites formed in the electrode due to electrochemical reactions, thus ensuring safety.

Specifically, the thickness of the metal-doped carbon film may be 100-300 nm. When the thickness of the carbon film is smaller than 100 nm, physical binding between the electrode surface and the coating film at the electrode interface may be problematic. In contrast, if it exceeds 300 nm, electrochemical performance may be unstable due to interrupted migration of lithium ions.

Specifically, the metal-doped carbon film may have a cluster size of 10-30 nm. When the cluster size is smaller than 10 nm, electrical conductivity may be low. And, when it exceeds 30 nm, surface density at the film interface may be undesirable.

Specifically, the carbon film may be prepared from fullerene. When general hydrocarbon compounds such as methane, ethylene, acetylene, etc., are used, problems may occur in film growth and inherent characteristics because of excess hydrogen included therein. Furthermore, electrochemical hysteresis may occur as a result of reaction between the proton ions present in the dangling bonds with lithium ions.

The metal doped in the carbon film may be one or more metal selected from a group consisting of tin, zinc, silver, aluminum and gallium. The metal doping decreases holes while increasing electron density of the film, thereby deteriorating surface resistance of the electrode active material.

The metal may be doped in an amount of 0.8-3.6 wt % based on the weight of the metal-doped carbon film. When the doping amount is less than 0.8 wt %, the doping effect is slight and the surface resistance may not be decreased sufficiently. And, when it exceeds 3.6 wt %, the metal may form a segregation mixture with carbon instead of being doped.

The electrode coated with a metal-doped carbon film may be prepared by a method comprising providing an electrode, a carbon precursor and a dopant metal precursor under plasma condition.

The electrode may be an electrode comprising an electrode active material, a conductor and a binder.

Specifically, the carbon precursor may be fullerene.

The dopant metal precursor may be a tin, zinc, silver, aluminum or gallium precursor.

Specifically, the plasma may be a plasma of 200-300 W and 10-30 A.

The present invention also provides a lithium secondary battery comprising the electrode.

### EXAMPLES

The examples and experiments will now be described. The following examples and experiments are for illustrative purposes only and not intended to limit the scope of this disclosure.

### Preparation Example 1

### Preparation of Electrode

A composite electrode was prepared using LiCoO₂ as a cathode active material. The active material, a conductor (acetylene black; AB) and a binder (polyvinylidene fluoride; PVDF) mixed at a weight ratio of 87:8:5 and stirred uniformly in NMP as dispersion medium using a high-speed agitator (5000 rpm). The resultant slurry was pasted on aluminum foil, dried at 80° C. for 1 hour, cut to a size of 2×2 cm², and pressed using a rolling press. Then, the amount of the active material was measured using a microbalance. The prepared electrode was dried in a vacuum oven at 80° C. for 12 hours in order to remove moisture.

### Example 1

Radio-frequency plasma condition was set at 220 W and 25 A, and pressure inside reactor was adjusted to 25 torr. After loading the electrode prepared in Preparation Example 1, tetramethyltin was supplied as a dopant metal precursor at a rate of 1.36 cc/min. Argon was supplied at 35 cc/min, and hydrogen at 3 cc/min. The amount of fullerene loaded in a furnace was set to 0.2 mg to coat 100 nm-thick carbon film.

FIG. 2 shows a transmission electron microscopic (TEM) image of the prepared tin-doped carbon film. The unit size of the resulting oval-shaped, tin-doped carbon clusters was about 10 nm-20 nm.

### Example 2

150 nm-thick carbon film was prepared in the same manner as in Example 1, except for setting the amount of fullerene loaded in the furnace to 0.3 mg.

### Example 3

Carbon film was prepared in the same manner as in Example 1, except for using tetramethylzinc as a dopant metal precursor.

### Comparative Example 1

The prepared electrode in Preparation Example 1 was not treated.

### Comparative Example 2

Carbon film was prepared in the same manner as in Example 1, except for not using the dopant metal precursor tetraethyltin. As a result, metal-undoped carbon film was coated.

### Test Example 1

### Evaluation of Battery Performance

The electrode prepared in Examples 1-3 or Comparative Example 1 was used as a working electrode of a half cell. Lithium metal foil was used as a counter electrode (or reference electrode), and electrolyte-wetted polypropylene (PP) was used as a separator. A full cell was prepared using a functionally treated active material as a working electrode and graphite as a counter electrode. The separator was the same as in the half cell. 1 M LiPF₆ dissolved in a 1:1:1 (volume) mixture of ethylene carbonate (EC), ethyl methyl carbonate (EMC) and dimethyl carbonate (DMC) was used as an electrolyte. The prepared half cell packaged using a pouch for an aluminum battery, and dry air in the pouch was removed using a vacuum packaging apparatus. All the battery assemblage procedure was carried out in a dry room where the relative humidity is maintained at 3% or lower.

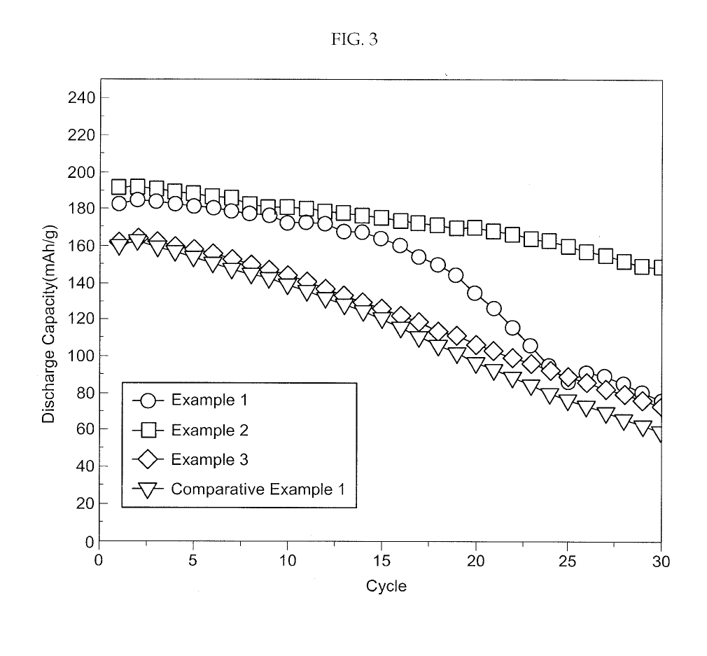

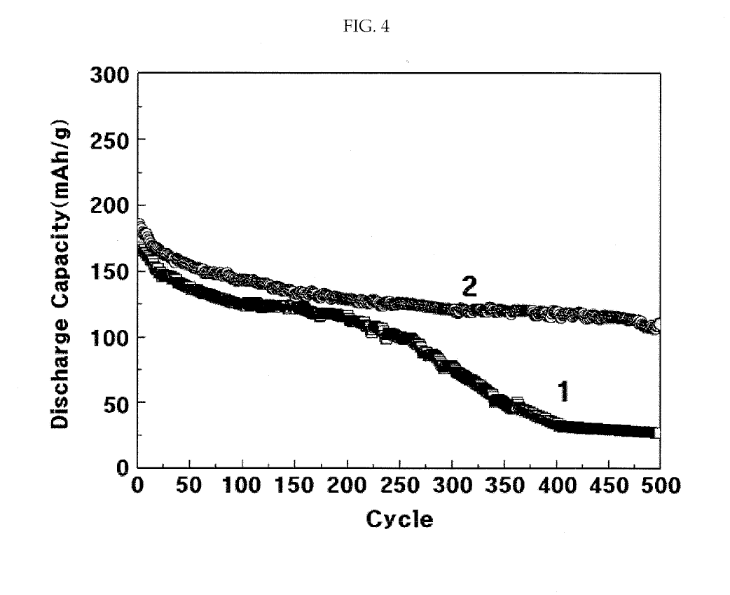

FIG. 3 shows a result of measuring discharge capacity for 30 cycles with a cut-off voltage of 3-4.5 V and a c-rate of 1 C, using the lithium cobalt oxide cathode prepared in Examples 1-3 or Comparative Example 1 as a working electrode and lithium metal foil as a counter electrode.

As seen from FIG. 3, the electrode of Comparative Example 1 showed a discharge capacity 180 mAh/g at the first cycle, which decreased to 64.5 mAh/g after 30 cycles. This reveals that SEI film is formed between the counter electrode (cathode) and the separator, as a result of which lithium cannot migrate to the cathode but forms LiO, thus resulting in reduced electrochemical efficiency. The electrode of Example 3 showed a better result than Comparative Example 1. The discharge capacity decreased to 80.3 mAh/g, 41.6% of the initial capacity, after 30 cycles.

Example 1 showed an initial capacity of 200 mAh/g, which decreased rapidly after about 15 cycles. After 30 cycles, the discharge capacity was almost the same as that of Comparative Example 1. In contrast, the initial capacity was maintained well in Example 2. After 30 cycles, the discharge capacity was 160.8 mAh/g, about 82% of the initial capacity, exhibiting a better efficiency than that of the existing electrode.

### Test Example 2

### Comparison of Surface Resistance of Electrode

The surface resistance of the electrodes of Examples 1-3 and Comparative

Examples 1-2 was measured by the 4-point probe method. The result is shown in Table 1.

TABLE 1

| | Surface resistance (Ω/□) |
|---|---|
| Example 1 | 1.0 × 10⁴ |
| Example 2 | 1.3 × 10² |
| Example 3 | 4.5 × 10² |
| Comparative Example 1 | 1.0 × 10¹⁴ |
| Comparative Example 2 | 2.0 × 10⁷ |

As seen from Table 1, the electrodes coated with the metal-doped carbon film according to the present invention show better surface resistance.

### Test Example 3

### Solid-State Nuclear Magnetic Resonance Analysis

Tin-doped carbon film was deposited on a silicon substrate used for analysis in the manufacture of an electrode. The substrate and the film were polished and diced with a thickness ratio of about 10:1. Then, the sample was washed in acetone for 10 minutes and treated with 1 M H₂SO₄ and 100 mL acetone at 120° C. for 3 minutes.

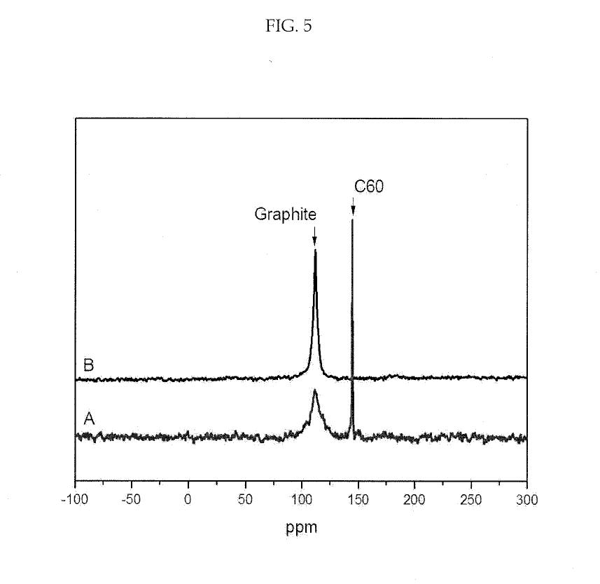

FIG. 5 shows that, in the metal-doped carbon film, the magnetic moment of the atomic nucleus absorbs the energy of the metal-doped carbon film and shifts to another energy level.

As seen from FIG. 5, the tin-undoped carbon film formed from C₆₀ precursor shows a broad amorphous carbon at 110 ppm and a C₆₀ peak around 145 ppm. In contrast, the tin-doped carbon film shows a narrow single peak at 110 ppm, revealing that the material is a novel material with graphene structure having superior electrical conductivity properties. That is to say, in FIG. 5, the sample coated with metal-undoped fullerene (A) shows both the graphite and C₆₀ peaks, but the sample coated with tin-doped fullerene (B) shows only the graphite peak.

In accordance with the present invention, the metal-doped carbon film covers the interface of the electrode active material where it contacts the electrolyte. Such an artificial interface improves ion and electrical conductivity of the electrode interface and prevents pass of water or electrolyte during electrochemical reactions, thereby preventing undesired reactions.

Since the electrode having the functional interface according to the present invention exhibits very superior cycle characteristics at high voltage, a lithium secondary battery comprising the same has high-capacity characteristics and allows fabrication of lightweight, large-sized mobile devices using it as power source.

While the present invention has been described with respect to the specific embodiments, it will be apparent to those skilled in the art that various changes and modifications may be made without departing from the spirit and scope of the disclosure as defined in the following claims.

1. An electrode coated with a metal-doped carbon film, wherein the electrode comprises a electrode active material selected from the group consisting of LiNiO₂, LiNiCoO₂, V₆O₁₃, V₂O₅ and MnO₂.

2-3. (canceled)

4. The electrode according to claim 1, wherein the electrode further comprises a conductor selected from the group consisting of acetylene black, carbon black, graphite and a mixture thereof.

5. The electrode according to claim 1, wherein the electrode further comprises a binder selected from the group consisting of vinylidene fluoride-hexafluoropropylene copolymer, polyvinylidene fluoride, polyacrylonitrile, poly(methyl methacrylate), polyamide and a mixture thereof.

6. The electrode according to claim 1, wherein the thickness of the metal-doped carbon film is 100-300 nm.

7. The electrode according to claim 1, wherein the metal-doped carbon film has a cluster size of 10-30 nm.

8. The electrode according to claim 1, wherein the carbon film is prepared from fullerene.

9. The electrode according to claim 1, wherein the metal doped in the carbon film is one or more metal selected from a group consisting of tin, zinc, silver, aluminum and gallium.

10. The electrode according to claim 1, wherein the metal is doped in an amount of 0.8-3.6 wt % based on the weight of the metal-doped carbon film.

11. A method for preparing an electrode coated with a metal-doped carbon film, comprising providing an electrode, a carbon precursor and a dopant metal precursor under plasma condition.

12. The method for preparing an electrode coated with a metal-doped carbon film according to claim 11, wherein the plasma is a plasma of 200-300 W and 10-30 A.

13. A lithium secondary battery comprising the electrode according to any one of claims 1 and 4 to 10.

14. An electrode coated with a metal-doped carbon film, wherein the electrode comprises a electrode active material selected from the group consisting of LiNiO₂, LiNiCoO₂, V₆O₁₃, V₂O₅ and MnO₂; a conductor made of graphite; and a binder selected from the group consisting of vinylidene fluoride-hexafluoropropylene copolymer, polyacrylonitrile, polyamide and a mixture thereof.
